(19) United States
(12) Patent Application Publication
(10) Pub. No.: US 2012/0304301 A1
(43) Pub. Date: Nov. 29, 2012

(54) CONFIDENTIALITY ANALYSIS SUPPORT SYSTEM, METHOD AND PROGRAM

(75) Inventor: Sayaka Izukura, Minato-ku (JP)

(73) Assignee: NEC CORPORATION, Minato-ku, Tokyo (JP)

(21) Appl. No.: 13/576,473

(22) PCT Filed: Jan. 19, 2011
(86) PCT No.: PCT/JP2011/000247

§ 371 Date: Aug. 1, 2012

(30) Foreign Application Priority Data
Feb. 2, 2010 (JP) 2010-021668

(51) Int. Cl. G06F 21/00

(52) U.S. Cl. 726/25

(57) ABSTRACT

Features of a confidentiality analysis support system include an attack flow model generating means that generates an attack flow model representing an attack flow which is likely to take place, as a model for analyzing confidentiality of an information system by assigning information which is defined independently from a connection state and a processing flow and which shows a function of a device, to a structure model representing the physical connection state of the device configuring the information system and a behavior model representing the processing flow executed in the device.

### TECHNICAL FIELD

This invention is concerning a confidentiality analysis support system, a confidentiality analysis support method and a confidentiality analysis support program which analyze confidentiality of an IT system.

### BACKGROUND ART

In recent years, accompanying development of an Internet technology, a value of an information asset (hereinafter, also referred to simply as “asset”) increases, and a leak accident of inside information of companies and personal information of clients is becoming a problem. It is demanded to construct a system which can prevent such a security accident in advance.

However, accompanying a larger scale and complication of an IT system, man-hours required for system development is increasing and much attention is not paid to a demand for confidentiality, and, therefore, there are many vulnerabilities which are not discovered until a system is actually operated.

Hence, it is important to construct a system which adequately reflects a demand for confidentiality from users by modeling a system in advance and estimating confidentiality to a certain degree at a design stage.

A common technique of this type proposes extending a modeling language such as UML (Unified Modeling Language) to describe knowledge related to confidentiality and modeling a security aspect of the system.

For example, Patent Literature 1 discloses a software developing device which assigns a stereotype indicating a security-related class, to a class diagram of application software and using a modeled software specification. Patent Literature 1 proposes a technique for making clear communication between security engineers and software developers with poor security knowledge by specifying <<security guaranteed>> or <verified>> as a stereotype of UML, to a class of service and indicating that this class is security requirement. Both parties have common understanding based on this additional information and, consequently, can cooperate in software development.

Further, for example, Patent Literature 2 discloses a method of extracting an access point based on information components configuring an analysis target system and performing security threat analysis based on this access point.

Furthermore, with a technique disclosed in Non Patent Literature 1, a regular (secure) processing flow is modeled using UMLsec which extends UML by adding a stereotype or a tagged value specialized in a security domain. Still further, this technique defines a function representing which operation of {delete, read, insert} an attacker can perform, and analyzes a threat for a system.

Moreover, Non Patent Literature 2 discloses modeling security requirement and a behavior of an attacker using this UMLsec. Moreover, Non Patent Literature 2 proposes a framework which supports design and analysis of a secure P2P application by model verification using a tool such as SPIN.

Further, with a technique disclosed in Non Patent Literature 3, a unique UML profile is defined, an authentication protocol is modeled, and whether or not an encrypted file is decrypted at a right location is verified.

Furthermore, Non Patent Literature 4 proposes SecureUML which extends UML for modeling role-based access control (RBAC). Still further, restriction (security policy) related to access control is generated from this model.

As described above, Non Patent Literature 4 proposes a method of constructing a security model using the modeling language such as UML, and analyzing a system. According to above Non Patent Literatures 1 to 4, how access control and a message are processed is modeled, and then what threat takes place is analyzed.

### CITATION LIST

### Patent Literature

PTL 1: Patent 2007-179171
PTL 2: Patent 2008-234409

### Non Patent Literature

NPL 1: “UMLsec: Extending UML for Secure Systems Development”, J. Jurjens, UML 2002 volume 2460 of LNCS, pp. 412-425, Springer-Verlag, 2002
NPL 2: “A Static Verification Framework for Secure Peer-to-Peer Application”, A. Zisman, Second International Conference on Internet and Web Applications and Services, ICIW'07
NPL 3: “For-LySa: UML for authentication analysis”, C. Montangero et al, Proceedings of the second workshop on Global Computing, volume 3267 of Lecture Notes in Computer Science, pp. 9205, Springer Verlag, 2004.
NPL 4: “SecureUML: A uml-based modeling language for model-driven security”, T. Lodderstedt et al, Proceedings of the International Conference on the Unified Modeling Language, UML'2002

### SUMMARY OF INVENTION

### Technical Problem

However, Patent Literature 1 discloses using a model which extends UML as a communication tool which allows security engineers and software developers to cooperate for system development, and does not mention to validity or effectiveness of this model.

Further, none of the above techniques takes into account a physical configuration state of a system because various behaviors of users and attackers are clipped and modeled.

That is, although what behavior users or attackers take change depending on what configuration a system employs, this is not taken into account.

For example, an attack model in Non Patent Literature 2 is created assuming a certain threat in advance, and what attack can be made is not derived from a physical system configuration.

Further, although flows of secure communication, decoding of messages and authority authentication are modeled according to Non Patent Literatures 1, 3 and 4, on what physical system configuration these flows can be executed is not taken into account.

Furthermore, detailed settings are not specified as to security requirement presented by a user when an IT system is actually designed and constructed, and the security requirement is represented as to whether or not the system has corresponding functions. Hence, a model which models a state of an authentication format which is executed by a common technique and executes this setting verification hardly reflects user's demand accurately.

Further, it is difficult to verify various security functions of a current large and complicated IT system, and therefore it is difficult to model and analyze the actual system using a notation (such as UMLsec) proposed by a common technique. Whether or not there is an overall security measure is requested by users, and analysis is required at such a level.

For example, the method disclosed in Patent Literature 2 does not take security functions of individual devices into account and therefore cannot analyze an overall security measure of the system.

It is therefore an object of the present invention to provide a confidentiality analysis support system, a confidentiality analysis support method and a confidentiality analysis support program which can analyze risks also taking into account flows of threats which take place depending on a physical configuration state of an analysis target system.

### Solution to Problem

A confidentiality analysis support system according to the present invention is characterized in including an attack flow model generating means that generates an attack flow model representing an attack flow which is likely to take place, as a model for analyzing confidentiality of an information system by assigning information which is defined independently from a connection state and a processing flow and which shows a function of a device, to a structure model representing the physical connection state of the device configuring the information system and a behavior model representing the processing flow executed in the device.

A confidentiality analysis support system according to the present invention is characterized in including: an attackable position determining means that determines an attackable position based on a physical arrangement of objects in a structure model of an analysis target system; and an attack flow model generating means that generates an attack flow model based on the structure model in which an actor representing an attacker is arranged at the position determined by the attack position determining means, a behavior model of the system and a security function of the object.

A confidentiality analysis support method according to the present invention is characterized in including generating an attack flow model representing an attack flow which is likely to take place, as a model for analyzing confidentiality of an information system by assigning information which is defined independently from a connection state and a processing flow and which shows a function of a device, to a structure model representing the physical connection state of the device configuring the information system and a behavior model representing the processing flow executed in the device.

A confidentiality analysis support program according to the present invention is characterized in causing a computer to execute attack flow model generating processing of generating an attack flow model representing an attack flow which is likely to take place, as a model for analyzing confidentiality of an information system by assigning information which is defined independently from a connection state and a processing flow and which shows a function of a device, to a structure model representing the physical connection state of the device configuring the information system and a behavior model representing the processing flow executed in the device.

### Advantageous Effects of Invention

According to the present invention, it is possible to analyze risks also taking into account flows of threats which take place depending on a physical configuration state of an analysis target system.

### BRIEF DESCRIPTION OF DRAWINGS

FIG. 1 illustrates a block diagram that illustrates a configuration example of a confidentiality analysis support system according to a first embodiment of this invention.

FIG. 2 illustrates a view that illustrates a specific example of a layout model stored in a system model storage means 10.

FIG. 3 illustrates a view that illustrates a specific example of a process model stored in the system model storage means 10.

FIG. 4 illustrates a view that illustrates a specific example of an allocation model stored in the system model storage means 10.

FIG. 5 illustrates a view that illustrates a specific example of the allocation model stored in the system model storage means 10.

FIG. 6 illustrates a view that illustrates a specific example of a behavior model 12 stored in the system model storage means 10.

FIG. 7 illustrates a view that illustrates a specific example of function information stored in a function information storage means 20.

FIG. 8 illustrates a view that illustrates a specific example of a security structure model generated by a security structure model generating means 30.

FIG. 9 illustrates a view that illustrates a specific example of a meta model stored in a meta model storage means 40.

FIG. 10 illustrates a view that illustrates a specific example of an attack model generated by an attack flow model generating means 50.

FIG. 11 illustrates a view that illustrates a specific example of an attack model generated by the attack flow model generating means 50.

FIG. 12 illustrates a flowchart that illustrates a processing example of the confidentiality analysis support system.

FIG. 13 is a block diagram that illustrates a configuration example of a confidentiality analysis support system according to a second embodiment.

FIG. 14 illustrates a specific example of function information stored in a function information storage means 20.

FIG. 15 illustrates a flowchart illustrating a processing example of the confidentiality analysis support system.

FIG. 16 illustrates a block diagram that illustrates a minimum configuration example of the confidentiality support system.

### DESCRIPTION OF EMBODIMENTS

### First Embodiment

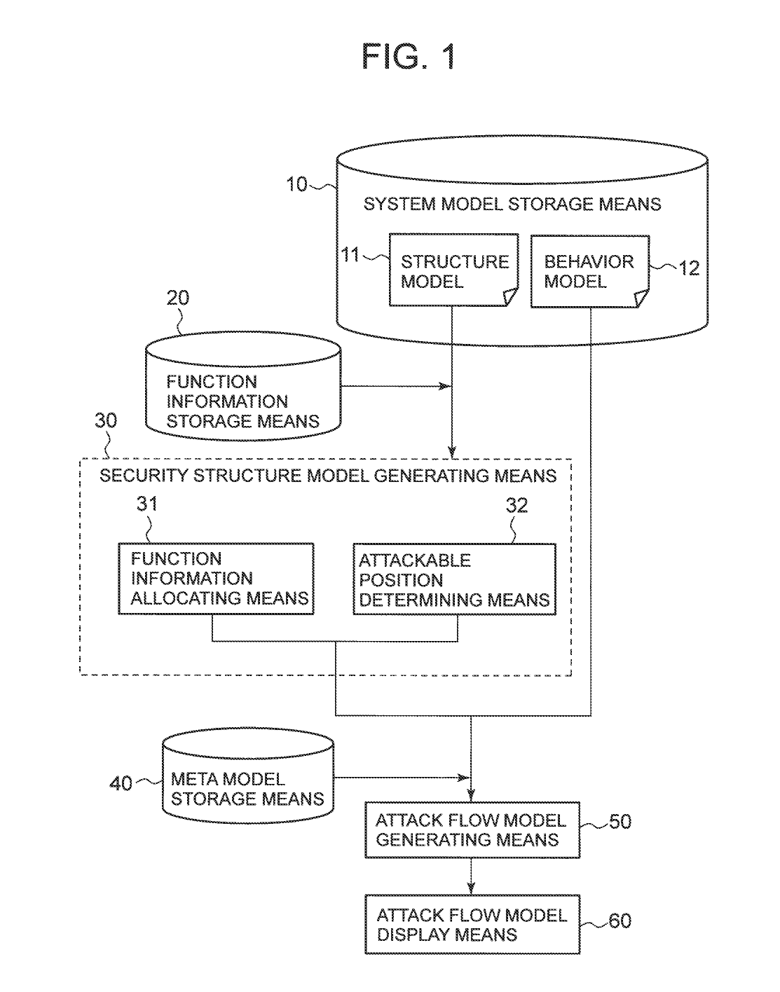

Hereinafter, examples of this invention will be described with reference to the drawings. FIG. 1 illustrates a block diagram that illustrates a configuration example of a confidentiality analysis support system according to the first embodiment of this invention. The confidentiality analysis support system according to this embodiment is realized specifically by an information processing device such as a personal computer which operates according to a program.

Referring to the block diagram of FIG. 1, the confidentiality analysis support system according to the first embodiment of this invention has a system model storage means 10, a function information storage means 20, a security structure model generating means 30, a meta model storage means 40, an attack flow model generating means 50 and an attack flow model display means. Further, the security structure model generating means 30 has an attackable position determining means 32 and a function information allocating means 31. Each means operates as follows.

The system model storage means 10 is realized specifically by a memory device such as a magnetic disc device or an optical disc device. The system model storage means 10 stores a structure model 11 representing configuration states of a physical device and process of an analysis target system, and a behavior model 12 representing in what flow in this device processing is performed. The structure model 11 includes a model (layout model) representing an arrangement of physical devices, a model of process (process model) executed on these devices and a model (allocation model) representing a correspondence between each object illustrated in these figures. These models are, for example, registered in the system model storage means 10 by an analyzer in advance.

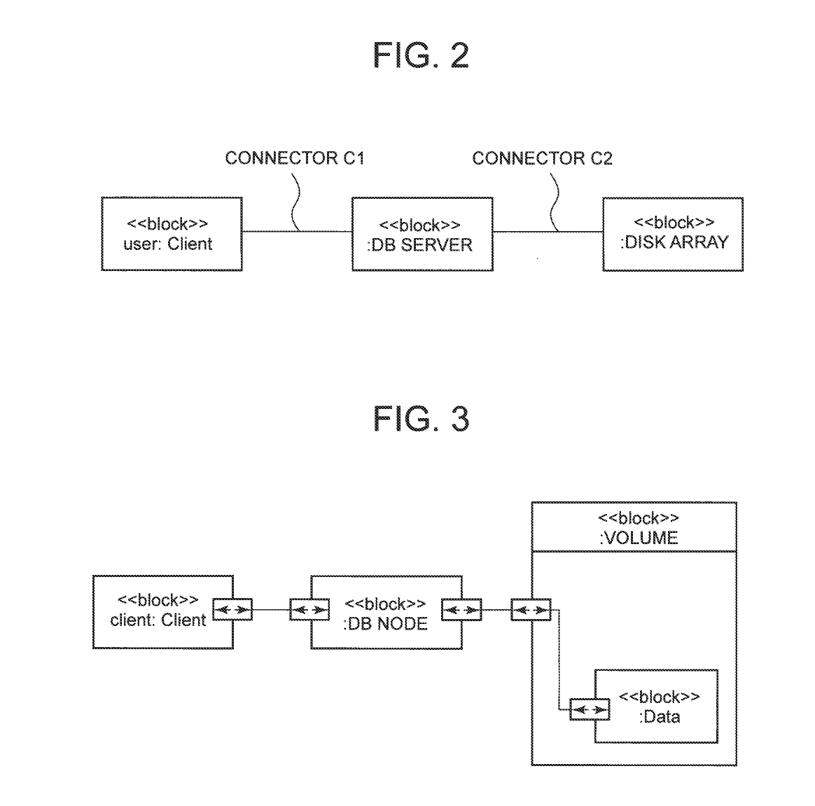

These system models are system designs described according to a modeling language such as UML or SysML (System Modeling Language). The structure model 11 is described by, for example, a composite structural diagram or an internal block diagram. Further, the behavior model 12 is described by, for example, a sequence diagram. Specific examples of the structure model 11 and the behavior model 12 are illustrated in FIG. 2 to FIG. 6.

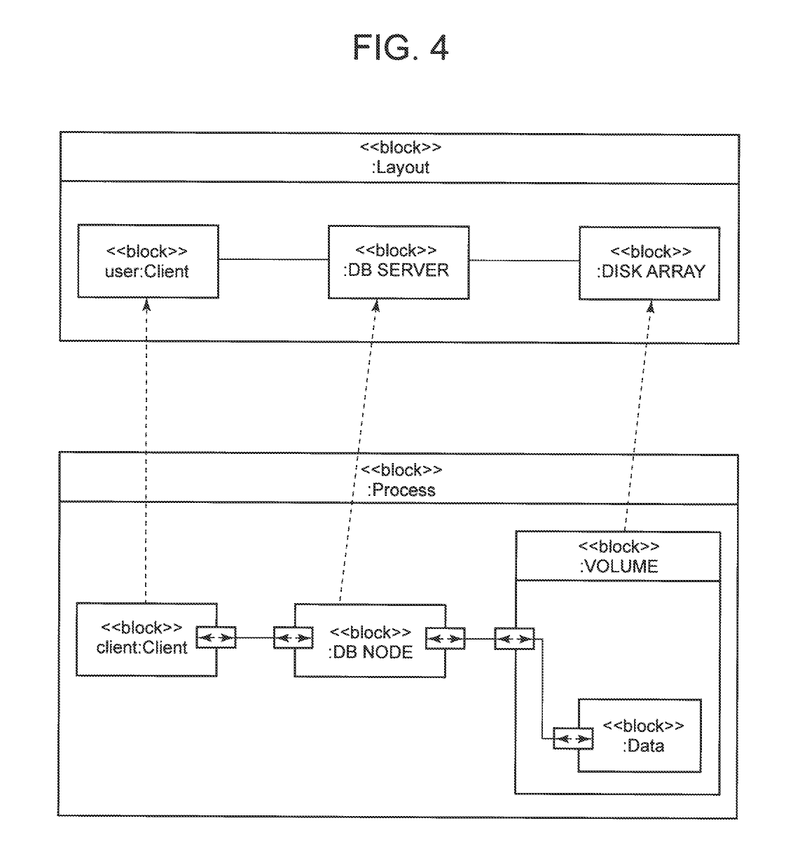

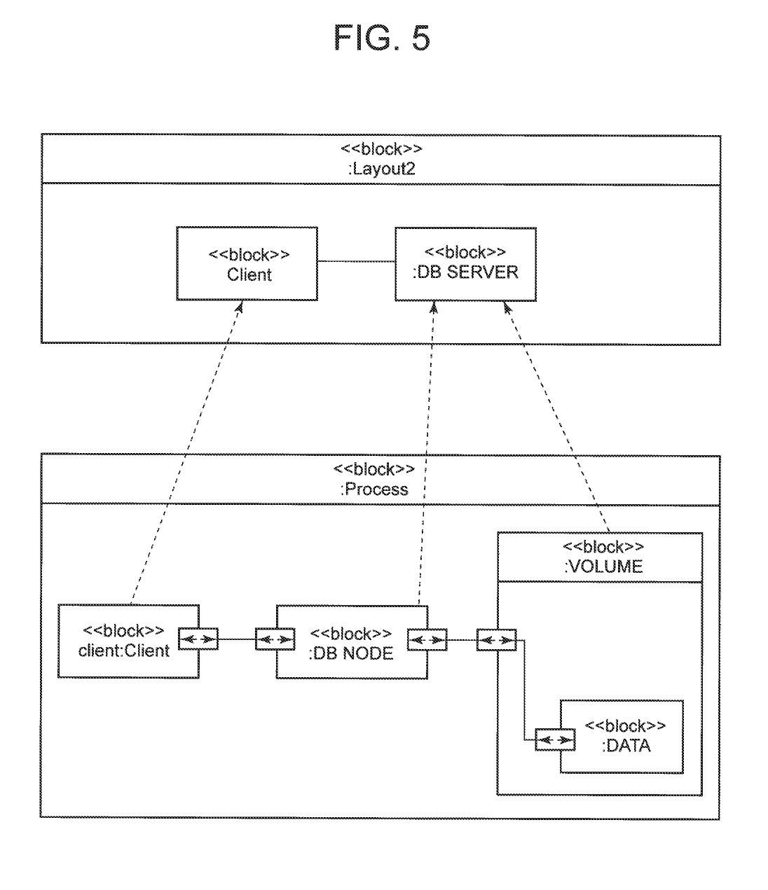

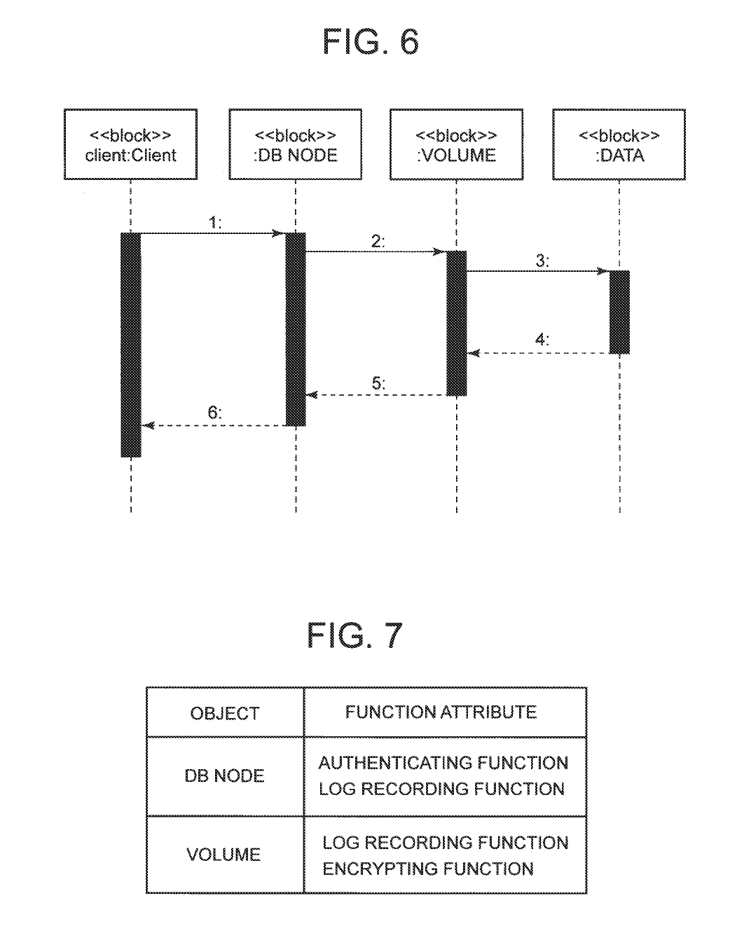

FIG. 2 illustrates a view that illustrates a specific example of the layout model stored in the system model storage means 10. Further, FIG. 3 illustrates an explanatory view that illustrates a specific example of the process model stored in the system model storage means 10. Furthermore, FIGS. 4 and 5 illustrate explanatory views that illustrate specific examples of the allocation models stored in the system model storage means 10. Still further, FIG. 6 illustrates a view that illustrates a specific example of the behavior model 12 stored in the system model storage means 10.

The function information storage means 20 is realized specifically by a memory device such as a magnetic disc device or an optical disc device. The function information storage means 20 classifies and stores function information indicating security functions such as an authenticating function and an encrypting function which a device configuring the system is likely to have, based on a stereotype of the device. Function information is, for example, registered in the function information storage means 20 by an analyzer in advance. FIG. 7 illustrates a specific example of function information stored in the function information storage means 20.

The security structure model generating means 30 is realized specifically by a CPU of an information processing device which operates according to a program. The security structure model generating means 30 has a function information allocating means 31 and an attackable position determining means 32.

The function information allocating means 31 has a function of allocating function information to each object described in the structure model 11 stored in the system model storage means 10. More specifically, the function information allocating means 31 assigns information showing a security function of an object as an attribute related to security (for example, features having the authenticating function and the log recording function), to each object described in the structure model 11. Hereinafter, information showing the attribute will be referred to as “attribute information” below. Further, information showing an attribute related to a security function will be referred to as “function attribute information” below.

The attackable position determining means 32 has a function of executing processing of determining an assumable position of an attacker in an analysis target system, and embedding information about the position in the structure model 11.

More specifically, the attackable position determining means 32 defines and arranges attackers as actors having various pieces of attribute information, on all connectors connecting physical objects in the structure model 11, and determines attack occurrence positions on corresponding process. That is, the attackable position determining means 32 generates a layout model and a process model, and a model (corresponding to a security behavior model which will be described below) which determines a position on process (=a portion at which an attack is likely to take place) corresponding to a physical position of an attacker based on a correspondence between the layout model and the process model. This model represents a flow of processing which an attacker instead of a client performs with respect to an asset, and is described by, for example, a sequence diagram similar to the behavior model 12.

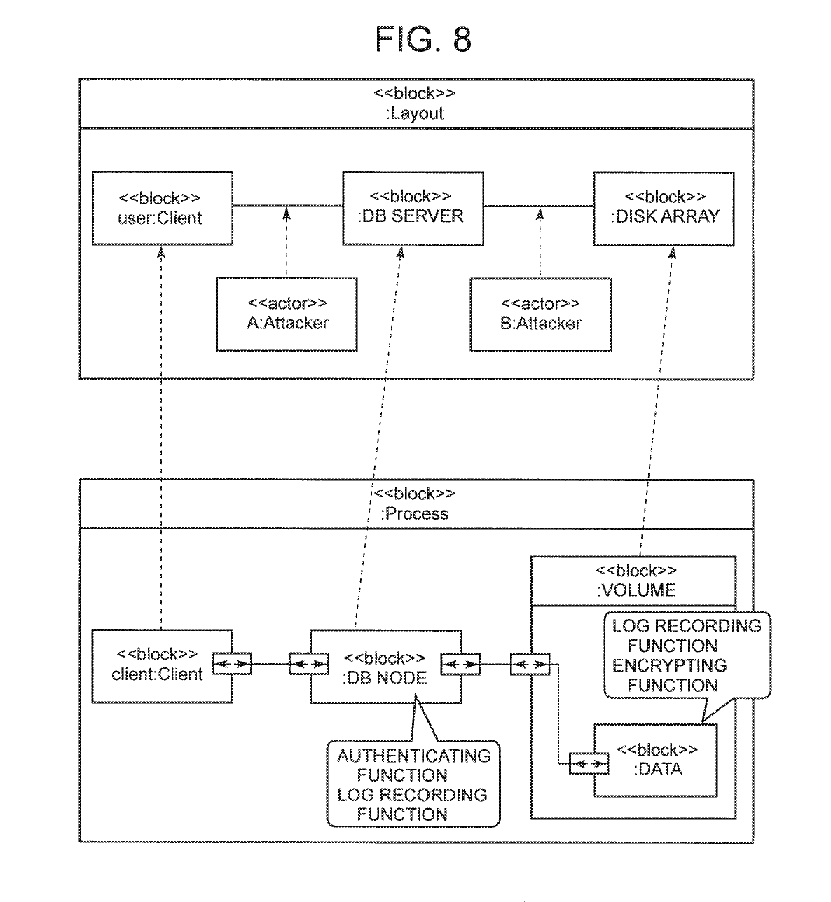

As described above, the security structure model generating means 30 generates a security structure model by assigning function attribute information showing a security function of each object and information showing a portion at which an asset is likely to be attacked, to the structure model 11. The security structure model can be described by, for example, a composite structural diagram or an internal block diagram similar to the structure model 11. FIG. 8 illustrates a specific example of the security structure model.

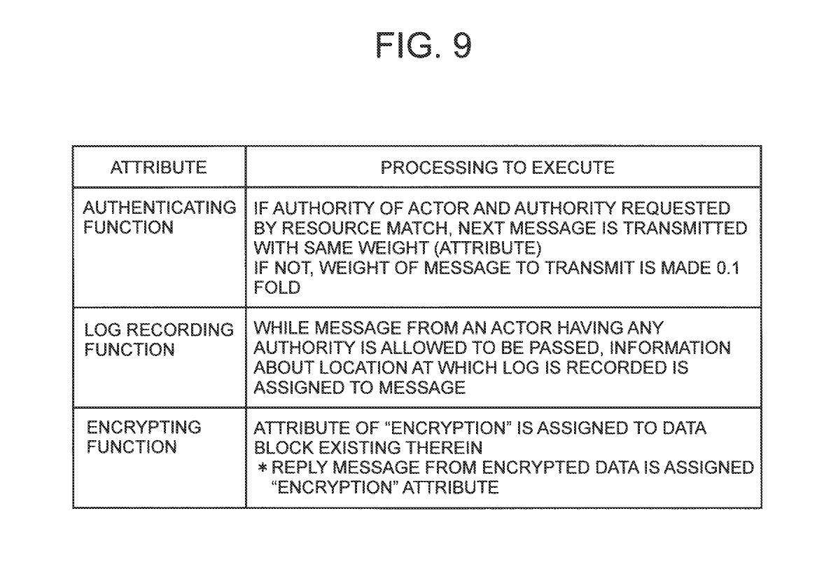

The meta model storage means 40 is realized specifically by a memory device such as a magnetic disc device or an optical disc device. The meta model storage means 40 stores information showing an operation executed by an object having a security function as a meta model. Meanwhile, the meta model is directed to, when an attacker reaches a predetermined object and goes for the next object, defining what attribute information this object assigns to an attacker (or a message sent by the attacker). In addition, with this embodiment, the operation defined by the meta model is realized by processing executed by an attack flow model generating means 60. The meta model is, for example, registered in the meta model storage means 40 by an analyzer in advance. FIG. 9 illustrates a specific example of an operation defined as a meta model.

The attack flow model generating means 50 is realized specifically by a CPU of an information processing device which operates according to a program. The attack flow model generating means 50 has a function of generating an attack flow model representing a flow of an attacker from the security structure model and the behavior model 12 to an asset, based on information defined by the meta model.

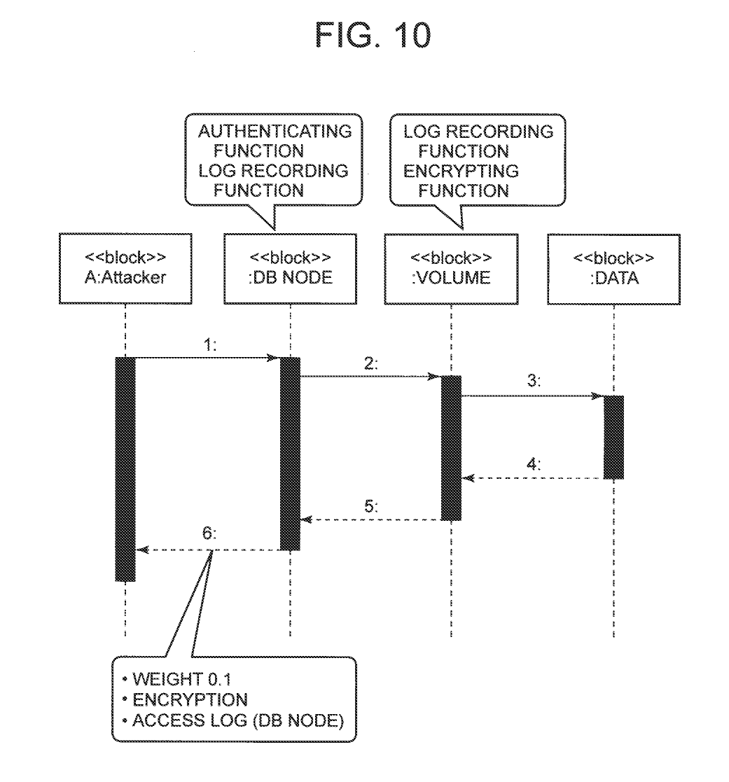

More specifically, the attack flow model generating means 50 lists (specifies) objects on a route which is described in the security structure model from an attacker to an asset, and transmits a message matching attribute information of the attacker, to an object adjacent to the attacker. Further, the attack flow model generating means 50 executes the operation defined by the meta model, to the message which has reached the object, and transmits a message to the next object. By repeating this processing until the message reaches an object having a stereotype which is an <<asset>> (hereinafter, referred to as an “asset object”) and returns to the attacker, the attack flow model generating means 50 adds various pieces of attribute information to the message propagating (being transmitted and received) between objects. FIG. 10 illustrates a specific example of an attack flow model generated by the attack flow model generating means 50.

The attack flow model display means 60 is realized specifically by a CPU which operates according to a program, or a display device or a printing means which displays, for example, a generated model or attribute information finally assigned to a message.

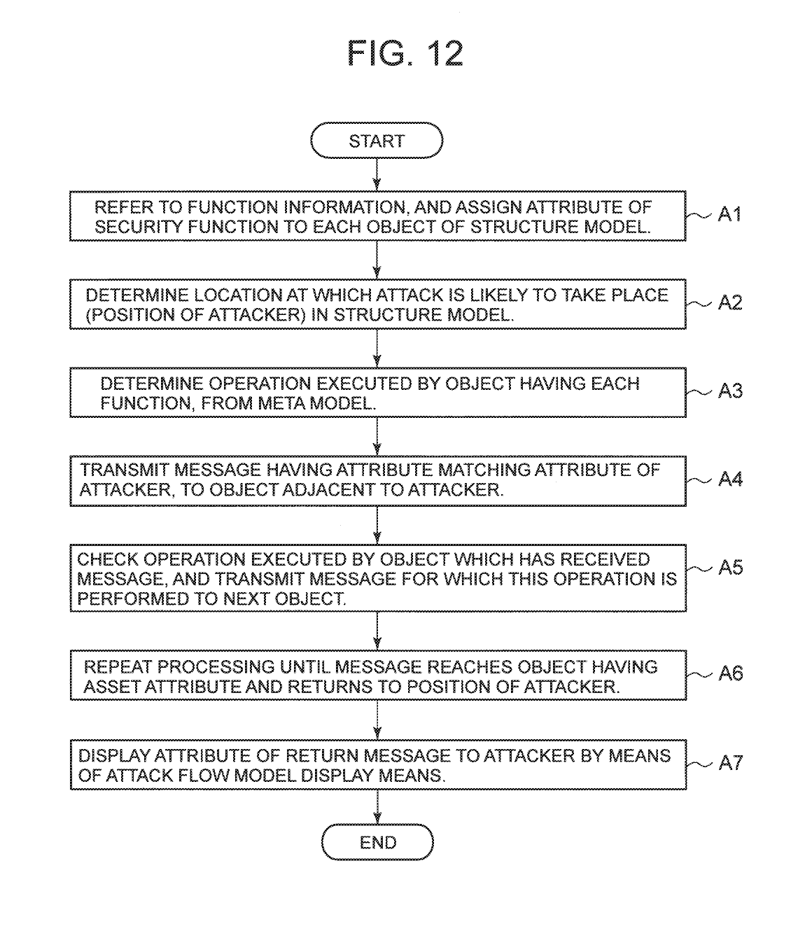

Next, a flow of processing executed by the confidentiality analysis support system according to this embodiment illustrated in FIG. 1 will be described with reference to FIG. 12. FIG. 12 illustrates a flowchart that illustrates a processing example of the confidentiality analysis support system.

To analyze confidentiality of a system model, an analyzer performs an operation of specifying an analysis target system model. Then, the function information allocating means 31 assigns function attribute information showing a security function based on function information, to each object described in the structure model 11 of the system model specified according to the analyzer's operation (step A1).

Next, the attackable position determining means 32 determines a location at which an attack is likely to take place, that is, a position of an attacker, in the structure model 11 (step A2). With this embodiment, in the physical structural diagram in the structure model 11, all connectors connecting objects are assumed as a location at which an attack is likely to take place.

Next, the attack flow model generating means 50 refers to a meta model stored in the meta model storage means, and determines what operation is performed for a message passing each object (step A3).

Subsequently, the attack flow model generating means 50 transmits a message including attribute information of the attacker, to an adjacent object from the position of the attacker determined in step A2 (step A4).

Next, the attack flow model generating means 50 performs the determining operation in step A3 for an object which has received the message, and then transmits the message to the next object (step A5).

Then, the attack flow model generating means 50 repeats processing in step A5 until the message reaches an asset object (step A6).

As described above, the attack flow model generating means 50 generates an attack flow model representing a flow which the attacker takes to reach the asset.

Finally, the attack flow model display means 60 displays the attack flow model generated by the attack flow model generating means 50 (step A7). For example, the attack flow model display means 60 makes a display device such as a display display the attack flow model. Further, for example, the attack flow model display means 60 prints the attack flow model as an output.

Next, an operation of the confidentiality analysis support system according to this embodiment will be described using a specific example. Hereinafter, an example will be described where an attack flow model is generated by applying the confidentiality analysis support system according to this invention to the system model (the structure model 11 and the behavior model 12) illustrated in FIGS. 2 and 6.

FIG. 2 illustrates the structure model 11 representing the system configuration. The structure model 11 includes a model (layout model: FIG. 2) representing the relationship of physical connection between devices, and a model (process model: FIG. 3) representing what process is executed in each device. The layout model and the process model are associated by another structure model (allocation model: FIG. 4).

Further, FIG. 6 illustrates the behavior model 12 which models a flow of processing in each process described in the above process model. This represents a flow of data when a regular client performs specific processing. With this embodiment, the structure model 11 is represented by an internal block diagram of SysML, and the behavior model 12 is represented by a sequence diagram.

FIG. 7 illustrates an example of function information stored in the function information storage means 20. In the function information, a security function of each object of the above system model is defined per, for example, a stereotype. With this embodiment, functions providing security effects are defined as an “authenticating function”, an “operation log recording function” and an “encrypting function”.

To analyze confidentiality of a system model, an analyzer performs an operation of specifying an analysis target system model. Then, the function information allocating means 31 specifies the analysis target system model according to the analyzer's operation, and assigns each of the above functions to each object of the system model having the same stereotype. Meanwhile, the function information allocating means 31 allocates the “authenticating function” and the “log recording function” to an object having a <<DB server>> stereotype. Further, the function information allocating means 31 allocates the “log recording function” and the “encrypting function” to an object having a <<disk array>> stereotype. More specifically, the function information allocating means 31 assigns function attribute information to an object.

Next, the attackable position determining means 32 decides from which position described in the system model attacks can take place, and arranges attackers (actors) having various pieces of attribute information at positions at which attacks can take place. Meanwhile, it is possible to make an attack from a connector connecting devices described in the layout model of the structure model 11. Hence, the attackable position determining means 32 arranges an actor on each connector (a connector c1 between the “client” and the “DB server” and a connector c2 between a “DB server” and a “disk array”), and assigns attribute information showing that the actor is at an attackable position.

Next, the attackable position determining means 32 refers to the allocation model, determines which position in the process model the position of the actor in the layout model corresponds to, and creates the model in which the actor is arranged as a security behavior model. With this embodiment, as illustrated in FIG. 4, an object of the layout model (FIG. 2) and an object of the process model (FIG. 3) are associated on a one-on-one basis. Hence, as illustrated in FIG. 10, the attackable position determining means 32 arranges an actor A and an actor B which represent attackers, between the client and the DB node and between the DB node and the volume on the process model.

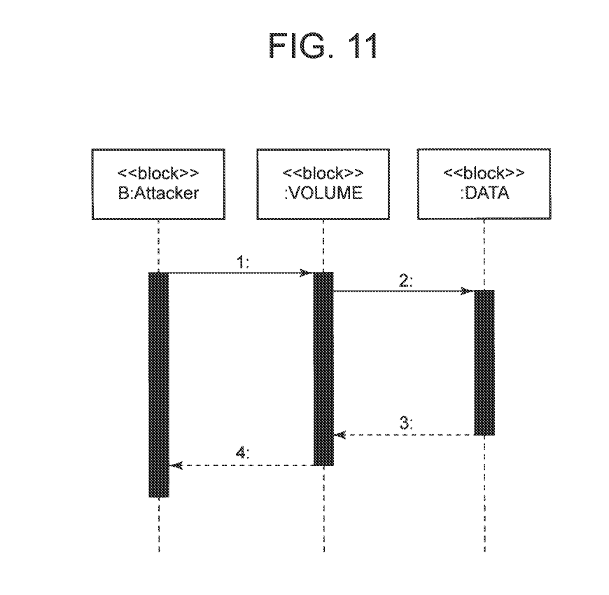

However, in case of, for example, the correspondence illustrated in FIG. 5, the “DB node” and the “volume” correspond to one “DB server”, and there is no actor between these processes, and therefore an attack does not take place therefrom. Hence, the attackable positions are only a location of an actor C between the client and the DB node and a location corresponding to the process, and therefore only attack patterns illustrated in FIG. 11 need to be considered.

Meanwhile, the meta model stored in the meta model storage means 40 represents information what operation an object having each of the above functions performs with respect to processing executed by an actor (a message transmitted from the actor).

Further, for example, in an object having the “authenticating function”, the attack flow model generating means 50 checks an authority of the actor which has transmitted the message and an authority requested by the object, and, when the authorities match, transmits a message with the same weight, to the next object. When the authorities do not match, the attack flow model generating means 50 transmits a message by decreasing a weight (for example, a 0.1 fold weight). Using this weight can represent that it is possible to prevent an attack from an actor to some degree using the object.

Further, in the object having the “encrypting function”, the attack flow model generating means 50 assigns attribution information of “encryption” to data included in the object. Furthermore, the attack flow model generating means 50 assigns “encryption” as attribute information to a message which has reached data including the attribute information of “encryption”, and replies the message to the actor.

Still further, when the object having the “log recording function” receives the message, the attack flow model generating means 50 generates an object of a “log file” in the object, and assigns information that an operation log is recorded in the object, to the message and transmits the message.

Hereinafter, an order that the attack flow model generating means 50 generates an attack flow model will be described. Meanwhile, the attacker assumes an outsider without an access right to devices on a route to confidential data (for example, asset) described in the structure model 11. That is, an operation of an actor without an authority (for example, shown by attribute information) of accessing each device is modeled. Further, although attackable positions are on the connectors c1 and c2 as described above, process of generating an attack flow model from c1 will be described.

First, in the above behavior model 12, the attack flow model generating means 50 utilizes a security behavior model in which an attacker is arranged instead of a client, and transmits a message including attribute information of the attacker to the “DB server” which is an adjacent object from the position of the attacker. Meanwhile, the assumed attacker is an outsider without a regular access right to the DB server, and therefore, the attack flow model generating means 50 transmits a message without the access right requested by the DB server.

When an object receives the message, the attack flow model generating means 50 checks attribute information assigned to the message and attribute information of the object, that is, function attribute information related to security, and performs an operation defined by the meta model. More specifically, the “DB server” has the “authenticating function”, and the attack flow model generating means 50 checks the authority of the actor and the authority requested by the “DB server”.

Meanwhile, these authorities do not match, and therefore the attack flow model generating means 50 changes a weight of a message to transmit from the “DB server” to a “storage server” which is the next object. With this embodiment, when the authorities do not match, the attack flow model generating means 50 makes the weight of the message to 0.1 fold as an example of an effect of access limitation by the authenticating function.

Further, the “DB server” has the “log recording function”, and the attack flow model generating means 50 generates an object of the “log file” in the “DB server” and assigns attribute information of “an access log to the DB server”, to the message to transmit to the “storage server”.

Next, the “storage server” which receives the message has the “log recording function”, and the attack flow model generating means 50 assigns attribute information of “the access log to the storage server”, to the message to transmit to “data” which is the next object. Further, the attack flow model generating means 50 generates the “log file” in the “storage server” similar to processing in the “DB server”.

Next, the “storage server” has the “encrypting function”, and the attack flow model generating means 50 assigns attribute information of “encryption” to “data” included in the “storage server”. By this means, when the message passes the “storage server” and reaches the “data”, the message returning from the “data” to the actor is assigned the attribute of “encryption”.

As described above, the message transmitted from the actor to the “data” propagates between objects while being assigned various attribute information, and is returned to the actor. Meanwhile, the message having attribute information of “the access log to the DB server/storage server” and attribute information of “encryption” is returned with a 0.1 fold weight of the message transmitted by the actor for the first time.

Then, the attack flow model display means 60 displays these attributes on, for example, a display device to present to the analyzer. The analyzer can decide whether or not the analyzed system model meets confidentiality requirement based on the information.

As described above, with this embodiment, physical configuration objects of a system is arranged in processing order of data, and is assigned attribute information defined as a meta model in advance to the message propagated between objects. Consequently, it is possible to model an attack flow which depends on a physical configuration of the system, and clarify the flow of threats.

### Second Embodiment

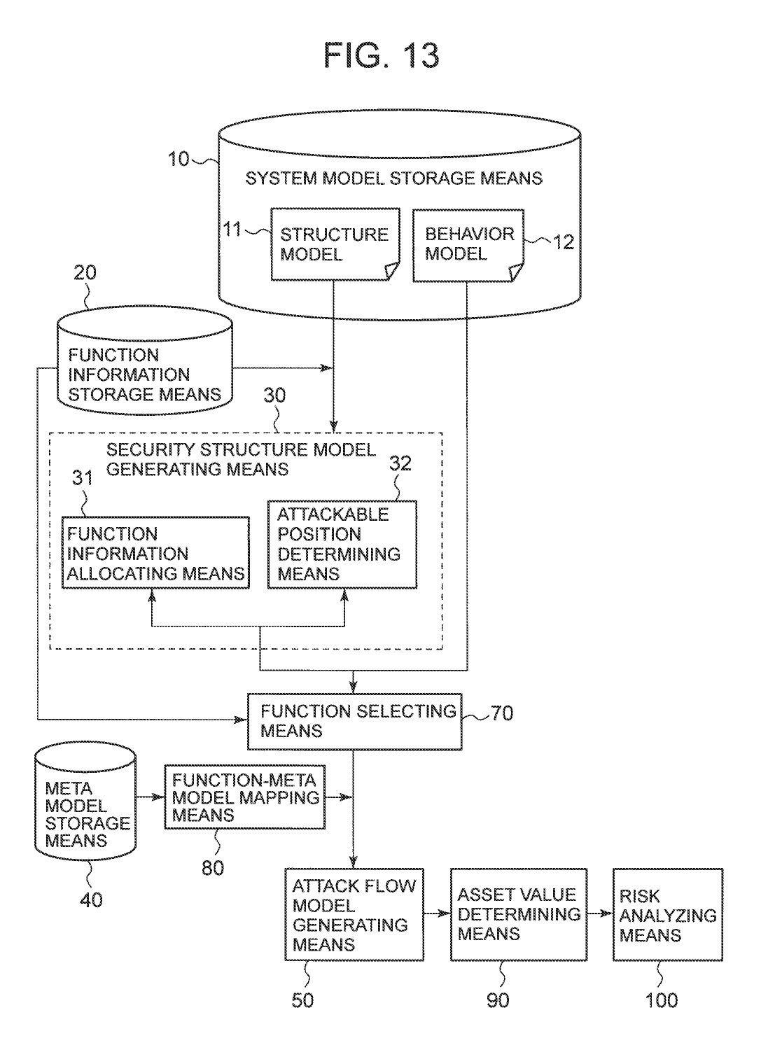

Next, the second embodiment of this invention will be described with reference to drawings. FIG. 13 is a block diagram that illustrates a configuration example of a confidentiality analysis support system according to the second embodiment. Referring to FIG. 13, the confidentiality analysis support system according to the second embodiment of this invention has a function selecting means 70, a function-meta model mapping means 80, an asset value determining means 90 and a risk analyzing means 100 in addition to the configuration according to the first embodiment.

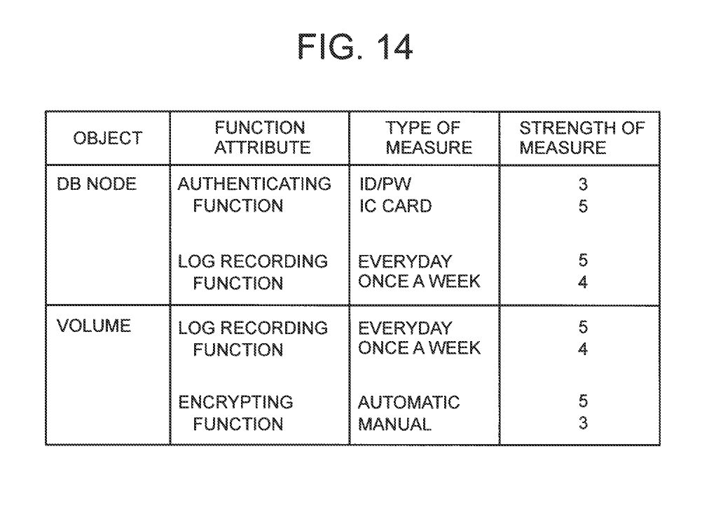

Further, a function information storage means 20 according to this embodiment stores information showing a specific measure for realizing a function and a strength of the measure in addition to function attribute information showing a security function of an object. FIG. 14 illustrates an explanatory view that illustrates a specific example of function information stored in the function information storage means 20 according to this embodiment. For example, as illustrated in FIG. 14, in function information, some specific measures for realizing authenticating functions such as “authentication according to ID/PW” or “authentication using an IC card”, and several stages of levels indicating a security strength of the measure are defined below the “authenticating function” indicating the security function. A specific measure for realizing a security function and several stages of levels indicating the security strength of the measure are defined by, for example, an analyzer in advance, and is registered in the function information storage means 20.

The function selecting means 70 is realized specifically by a CPU of an information processing device which operates according to a program. The function selecting means 70 has a function of selecting information indicating specifically what measure is taken to realize the security function in the analysis target system model, from the above function information according to an analyzer's selecting operation. That is, information assigned to the system model (structure model 11) by the function information allocating means 31 is a concept of a function related to security for each object, and therefore a specific measure for realizing this function is selected from options of some measures by the analyzer.

The function-meta model mapping means 80 is realized specifically by a CPU of an information processing device which operates according to a program. The function-meta model mapping means 80 has a function of assigning a weight in response to an operation selected by the function selecting means 70, performed according to the specific security measure and defined in the meta model.

The function-meta model mapping means 80 adds information that the weight is 0.1 fold in case that the strength is 5 or the weight is 0.4 fold in case that the strength is 3, to an operation defined according to the meta model stored in the meta model storage means 40. By this means, the attack flow model generating means 50 according to this embodiment executes each operation defined in the meta model by assigning several stages of weights.

The asset value determining means 90 is realized specifically by a CPU of an information processing device which operates according to a program. The asset value determining means 90 has a function of determining what value an asset of an analysis target system has. For example, the asset value determining means 90 determines the importance of the asset of the analysis target system as asset value information based on information showing several stages of an asset value inputted by the analyzer and a correspondence table prepared in advance. With this embodiment, a risk of the analysis target system changes according this asset value information.

The risk analyzing means 100 is realized specifically by a CPU of an information processing device which operates according to a program. The risk analyzing means 100 has a function of qualitatively or quantitatively calculating a risk (for example, information leak risk) with respect to an asset, from attribute information of a message described in an attack flow model and asset value information, and presenting the risk to the analyzer.

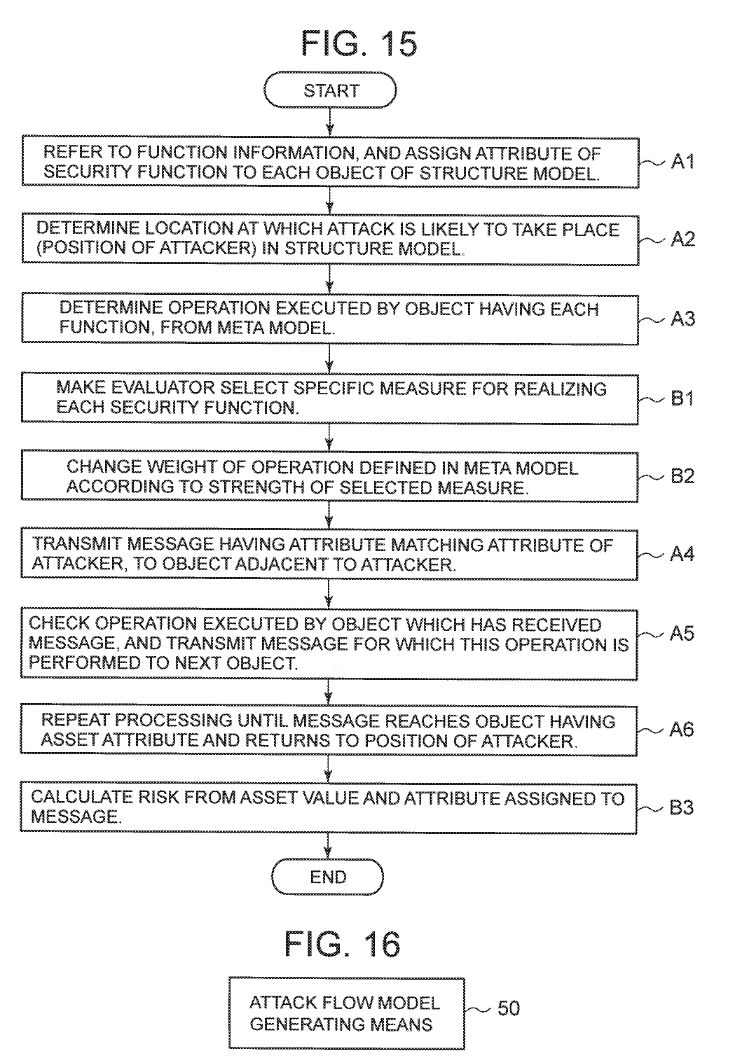

Next, processing of the confidentiality analysis support system according to this embodiment will be described with reference to FIG. 15. FIG. 15 illustrates a flowchart that illustrates a processing example of the confidentiality analysis support system according to this embodiment. In addition, a flow up to generation of an attack flow model according to this embodiment is the same as processing according to the first embodiment except a new step inserted between processing steps A3 and A4 according to the first embodiment illustrated in FIG. 12.

When assignment of various pieces of attribute information to each object configuring the system model is finished according to processings up to step A3 in FIG. 12, the analyzer performs an operation of selecting from function information a specific measure (hereinafter, security measure) for executing a function of an object. Then, the function selecting means 70 selects information showing a specific security measure for executing a function according to the analyzer's selecting operation (step B1).

Next, the function-meta model mapping means 80 changes a weight of an operation with respect to the message defined in the meta model stored in the meta model storage means 40 according to the strength of the security measure selected in step B1.

Subsequently, a flow of generating the attack flow model by the attack flow model generating means 50 is the same as steps subsequent to step A4 in FIG. 12. Meanwhile, when attribute information is assigned to the message in step A5, the attack flow model generating means 50 also assigns attribute information showing “a weight of an operation” changed in step B2.

Further, when the attack flow model is generated in step A6, the risk analyzing means 100 qualitatively or quantitatively calculates a risk value in the system, from attribute information assigned to a replay message to an attacker and asset value information in the analysis target system. Furthermore, the risk analyzing means 100, for example, displays a calculation result on a display device, and presents the calculation result to the analyzer (step B3).

With this embodiment, a level representing the strength matching a type of a measure (realizing method) is set in advance to the security function of each object in the analysis target system model, and the measure which realizes the security function is selected by the user. Consequently, it is possible to construct a more specific system model, analyze confidentiality and actually construct the system.

A first effect obtained by the confidentiality analysis support system according to each of the above embodiments includes modeling a behavior of an attacker which depends on a physical system configuration state and analyzing a flow of a threat which is likely to take place in the system by assigning an operation of an object configuring the system, to a message from the attacker passing over the operation.

A second effect includes generating an individual system model (instance) which specifically specifies the security function introduced to each system from one system model by providing a certain margin of the effect of the security function and making each analysis target system select the effect, and constructing an adequate system which meets confidentiality request from users.

Although this invention has been described based on preferred embodiments above, the confidentiality analysis support system according to this invention is by no means limited to the configurations of the above embodiments, and configurations variously modified and changed are included in the scope of this invention.

Upon comparison with the above prior art, with this invention, information related to a security function is defined to a system model (a structure model and a behavior model corresponding to a system design diagram) accumulated in advance separately from a system structure or processing performed in the system structure. Further, an attribute assigned to an attack flow model changes according to this function. Furthermore, this attack flow model includes information showing an attribute related to functions of a device and information showing a weight attribute representing an occurrence frequency of a threat.

In view of above, this invention has the following features. Features of a confidentiality analysis support system according to an aspect of this invention include generating an attack flow model representing an attack flow which is likely to take place by assigning information which is defined independently from connection states and a processing flow and which shows a function of a device, to a structure model representing the physical connection states of a plurality of devices configuring the information system and a behavior model representing the processing flow executed in the device, and analyzing confidentiality in the information system.

Further, features of the confidentiality analysis support system according to another aspect of this invention include comparing confidentiality of some system models by defining a measure for realizing a security function of each object described in a structure model per level of several stages according to the strength of the measure, and making an evaluator select a specific measure.

Next, a minimum configuration of the confidentiality analysis support system according to this invention will be described. FIG. 16 illustrates a block diagram that illustrates a minimum configuration example of the confidentiality analysis support system. As illustrated in FIG. 16, the confidentiality analysis support system includes an attack flow model generating means 50 as a minimum component.

With the confidentiality analysis support system employing the minimum configuration illustrated in FIG. 16, the attack flow model generating means 50 generates an attack flow model representing an attack flow which is likely to take place by assigning information which is defined independently from a connection state and a processing flow and which shows a function of a device, to a structure model representing the physical connection state of the device configuring the information system and a behavior model representing the processing flow executed in the device.

Consequently, the confidentiality analysis support system employing the minimum configuration can model a flow of threats which take place depending on a physical configuration state of an analysis target system, and analyze a risk.

In addition, with this embodiment, characteristic configurations of the confidentiality analysis support system as described in following (1) to (8) are described.

(1) Features of a confidentiality analysis support system has an attack flow model generating means (realized by, for example, the attack flow model generating means 50) that generates an attack flow model representing an attack flow which is likely to take place, by assigning information (such as function attribute information) which is defined independently from a connection state and a processing flow and which shows a function of a device, to a structure model (such as structure model 11) representing the physical connection state of the device configuring the information system and a behavior model (such as the behavior model 12) representing the processing flow executed in the device.

(2) The confidentiality analysis support system may be configured such that the attack flow model generating means generates the attack flow model using a layout model representing the connection state of the physical device configuring the information system and a process model representing process executed by the device.

(3) The confidentiality analysis support system may configured such that the attack flow model generating means generates the attack flow model using the behavior model representing a flow of a message propagating between objects configuring a process model per processing executed by the information system.

(4) The confidentiality analysis support system may be configured such that the attack flow model generating means generates the attack flow model including a security function of each object described in the structure model and information based on a meta model (such as a meta model stored in the meta model storage means 40) which defines an operation executed by the object in response to an access to the object.

(5) The confidentiality analysis support system may be configured such that the attack flow model generating means generates the attack flow model using a meta model including information showing an attribute to be assigned to at least one of a message which has arrived at each object or a message sent from the object by a security function.

(6) The confidentiality analysis support system may be configured such that the attack flow model generating means assigns information (such as attribute information) showing an attribute to a message which has passed an object in the attack flow model.

(7) The confidentiality analysis support system may have a function selecting means (realized by, for example, the function selecting means 70) that selects a measure for realizing a security function of each object described in the structure model, the security function being defined in advance together with security strength, and may be configured such that the attack flow model generating means generates an attack flow model based on the measure selected by the function selecting means.

(8) A confidentiality analysis support system may be configured to have: an attackable position determining means (realized by, for example, the attackable position determining means 32) that determines an attackable position based on a physical arrangement of objects in a structure model (such as the structure model 11) of an analysis target system; and an attack flow model generating means (realized by, for example, the attack flow model generating means 50) that generates an attack flow model based on the structure model (such as the security structure model) in which an actor representing an attacker is arranged at the position determined by the attack position determining means, a behavior model (such as the security behavior model) of the system and a security function of the object.

Although this invention has been described with reference to embodiments and examples, this invention is by no means limited to the above embodiments and the examples. The configuration and details of this invention can be variously changed within a scope of this invention which one of ordinary skill can understand.

This application claims priority to Japanese Patent Application No. 2010-021668 filed on Feb. 2, 2010, the entire contents of which are incorporated by reference herein.

### INDUSTRIAL APPLICABILITY

This invention is applicable for use in analyzing confidentiality of a system.

### REFERENCE SIGNS LIST

10 Symbol model storage means
11 Structure model
12 Behavior model
20 Function information storage means
30 Security structure model generating means
31 Function information allocating means
32 Attackable position determining means
40 Meta model storage means
50 Attack flow model generating means
60 Attack flow model display means
70 Function selecting means
80 Function-meta model mapping means
90 Asset value determining means
100 Risk analyzing means

1-10. (canceled)

11. A confidentiality analysis support system characterized in comprising an attack flow model generating unit that generates an attack flow model representing an attack flow which is likely to take place, as a model for analyzing confidentiality of an information system by assigning information which is defined independently from a connection state and a processing flow and which shows a function of a device, to a structure model representing the physical connection state of the device configuring the information system and a behavior model representing the processing flow executed in the device.

12. The confidentiality analysis support system according to claim 1, wherein the attack flow model generating unit generates the attack flow model using the structure model including a layout model representing the connection state of the physical device configuring the information system and a process model representing process executed by the device.

13. The confidentiality analysis support system according to claim 11, wherein the attack flow model generating unit generates the attack flow model using the behavior model representing a flow of a message propagating between objects configuring a process model per processing executed by the information system.

14. The confidentiality analysis support system according to claim 11, wherein the attack flow model generating unit generates the attack flow model including a security function of each object described in the structure model and information based on a meta model which defines an operation executed by the object in response to an access to the object.

15. The confidentiality analysis support system according to claim 11, wherein the attack flow model generating unit generates the attack flow model using a meta model including information showing an attribute to be assigned to at least one of a message which has arrived at each object or a message sent from the object by a security function.

16. The confidentiality analysis support system according to claim 11, the attack flow model generating unit assigns information showing an attribute to a message which has passed an object in the attack flow model.

17. The confidentiality analysis support system according to claim 11, comprising a function selecting unit that selects a measure for realizing a security function of each object described in the structure model, the security function being defined in advance together with security strength,
the attack flow model generating unit generates an attack flow model based on the measure selected by the function selecting unit.

18. A confidentiality analysis support system characterized in comprising:
an attackable position determining unit that determines an attackable position based on a physical arrangement of objects in a structure model of an analysis target system; and
an attack flow model generating unit that generates an attack flow model based on the structure model in which an actor representing an attacker is arranged at the position determined by the attack position determining unit, a behavior model of the system and a security function of the object.

19. A confidentiality analysis support method characterized in comprising generating an attack flow model representing an attack flow which is likely to take place, as a model for analyzing confidentiality of an information system by assigning information which is defined independently from a connection state and a processing flow and which shows a function of a device, to a structure model representing the physical connection state of the device configuring the information system and a behavior model representing the processing flow executed in the device.

20. A computer readable information recording medium storing a confidentiality analysis support program, when executed by a processor, performs a method for:
attack flow model generating processing of generating an attack flow model representing an attack flow which is likely to take place, as a model for analyzing confidentiality of an information system by assigning information which is defined independently from a connection state and a processing flow and which shows a function of a device, to a structure model representing the physical connection state of the device configuring the information system and a behavior model representing the processing flow executed in the device.
